(19) United States
(12) Patent Application Publication
(10) Pub. No.: US 2005/0074623 A1
(43) Pub. Date: Apr. 7, 2005

(54) Multi-layer lonomer sheet having improved weathering

(76) Inventor: Randall Allen Vogel, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/960,454

(22) Filed: Oct. 7, 2004

Related U.S. Application Data
(60) Provisional application No. 60/509,188, filed on Oct. 7, 2003.

(51) Int. Cl. B32B 5/16; B32B 27/34; B32B 27/32

(52) U.S. Cl. 428/520; 428/523; 428/323; 428/333

(57) ABSTRACT

A thermoplastic multi-layer sheet is disclosed which comprises a first thick clear thermoplastic polymeric polyolefin, a second polymeric layer, and optionally, a third thermoformable polymeric adhesive layer, and further optionally, a co-extruded backing layer adhered to the adhesive layer.

This application claims priority from Provisional U.S. Patent Application Ser. No. 60/509,188, filed Oct. 7, 2003, the entire disclosure of which is incorporated herein by reference.

### BACKGROUND OF THE INVENTION

This invention is directed to a thermoplastic surfaced sheet, particularly a polyolefin surfaced sheet and in particular to a multi-layer sheet or laminate that has improved weathering and is particularly useful for body panels and parts for automotive, truck, recreational, lawn and garden vehicles.

There is a need for thermoplastic surfaced sheet materials that have excellent resistance to weathering. A typical thermoplastic multi-layer sheet or laminate for exterior use has a clear surface layer and a pigmented under layer. These sheets or laminates are used to make contoured parts, such as parts for autos and trucks, like panels, fascia parts and used to make parts for recreational vehicles by conventional thermoforming processes. Typically, after thermoforming the sheet or laminate into a contoured surfacing part, it is placed into a mold and compressed or injection cladded onto a substrate to provide stiffness and handleability to the part. It would be desirable to have thermoplastic sheet material that has an acceptable finish after the formation of a part that does not require additional painting or the application of an additional coating but results in a part in which weathering durability is suitable for exterior surfaces and is similar to or better than paint in performance and in appearance after weathering.

Non polyolefin surfaced laminate constructions such as paint, acrylonitrile/styrene/acrylate copolymers (ASA) and fluoropolymer paint film constructions, for example, PVF or PVDF, typically have a thin clear surface layer. The clear surface layer is typically less than 3 mils (approximately 75 μ) and more typically less than 2 mils (approximately 50 μ). The clear surface layer provide a top layer suitable for loading relatively high levels of ultra-violet light absorbing materials to enhance weathering durability, probably by reducing the amount of ultra-violet light penetrating to the underlayers. The clear layer also enhances surface gloss and reduces the appearance of mars and scratches on the surface, relative to having a pigmented surface layer.

Improving weathering durability in polyolefins has been accomplished typically through additives. These additives are either weathering additives known in the art, such as ultra-violet light absorbers or stabilizers, or pigments, especially carbon black, or a combination of these. Often these approaches extend bulk mechanical properties of an article, such as elongation or strength during extended periods of outdoor exposure, but do not maintain desirable appearance surface properties, such as gloss.

For example, WO 02/066249 discloses co-extruded pigment/clear coated polymeric coatings. Japanese Kokai Patent Application SHO 58[1983}-155953 discloses molded polyolefin resin laminates.

There is a need for a thermoplastic polyolefin surfaced sheet material or laminate having a clear layer and a pigmented underlayer that exhibits desirable surface properties that are similar to or better than a painted surface. Such a sheet material or laminate is preferably thermoformable to form parts that can be cladded to form a part having weathering durability similar to or better than paint along with other properties, such as temperature resistance and scratch, scuff and mar resistance and also is durable so that it can be used for the exterior of automobiles, trucks and recreational vehicles without the application of additional finishes or coatings.

### SUMMARY OF THE INVENTION

The invention comprises a thermoplastic multi-layer sheet or laminate with a thick surface layer comprising or produced from (a) a first thick, clear, thermoplastic polymeric polyolefin surface layer and (b) a second polymeric layer containing pigments, dyes, flakes and any mixtures thereof.

### DETAILED DESCRIPTION OF THE INVENTION

The multi-layer sheet or laminate with a thick surface layer can comprise or be produced from

(a) a first, thick, clear thermoplastic polymeric polyolefin surface layer, preferably comprising an ethylene copolymer surface layer, and more preferably, a neutralized ethylene acid copolymer or an ionomer resin of ethylene having a co-monomer content between 8-25% by weight, based on the weight of the copolymer, of a C₃-C₈ α,β ethylenically unsaturated mono-carboxylic acid with at least 35% of the acid moieties neutralized with metal ions, preferable a mixture of metal ions in which the polymeric layer can be 100 to 450 μ in thickness and contains 0.2 to 3.0 parts per hundred by weight, based on the copolymer or ionomer resin, of at least one hinder amine light stabilizer to provide improved weatherability;

(b) a second polymeric layer (or under layer) preferably selected from an ionomer resin, an ethylene acid copolymer, an ethylene acid terpolymer, and ethylene copolymer or a metallocene catalyzed very low density polyethylene (m-VLDPE) and contains pigments, dyes, flakes, additives and any mixtures thereof;

(c) optionally, a third thermoformable polymeric adhesive layer that is in direct contact with the second polymeric layer and

(d) further optionally a backing layer (fourth layer) in which the adhesive layer can be formulated to provide adhesion to alternative backing layers (e.g., metallocene-catalyzed very low density polyethylene (m-VLDPE) can be suitable and provide high adhesion for adhering and ionomer resin of the second layer to a backing layer, for example of polypropylene, and a fourth polymeric backing layer adhered to the adhesive layer).

The components or products that are formed from the above multi-layer sheet can have excellent weatherability. The components or products can be formed by thermoforming the multi-layer sheet and then cladded with any of a group of polymers, such as polypropylene, TPO (thermoplastic polyolefin), blends of ionomer resins and polyethylene, polyesters, such as polyethylene terephthalate and blends of polyethylene terephthalate and polybutylene terephthalate, polyamides and polyamide copolymers and their blends to form parts and panels for autos, trucks, recreational vehicles and the like.

References in the singular may also include the plural (for example, “a” and “an” may refer to one, or one or more) unless the context specifically states otherwise. The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

“(Meth)acrylic acid” means acrylic acid and methacrylic acid and the term “(meth)acrylate means acrylate and methacrylate.

“Distinctness of Image” or “DOI” is a measure of the “degree of definition” of a reflection of an object in a colored finish compared to the actual object itself. DOI is defined in ASTM Standard-284 as: distinctness-of-image-gloss, n-aspect of gloss characterized by the sharpness of images of objects produced by reflection at a surface. DOI can be measured with a BYK-Gardner Wavescan DOI instrument. In the automotive industry, satisfactory finishes on a smooth or “Class A” surface typically will have a DOI value of at least 60 and preferably, 80 or higher.

“Gloss” is defined in ASTM Standard-284 as, n-angular selectivity of reflectance, involving surface reflected light, responsible for the degree to which reflected highlights or images of objects may be superimposed on a surface.

“Melt Index” (MI) of a polymer is determined by ASTM D 1238 using condition E (2190 g, 190° C.).

“Haze” is defined in ASTM Standard-284 as: n-scattering of light at the glossy surface of a specimen responsible for the apparent reduction in contrast of objects viewed by reflection from the surface.

“Class A surface” is a surface that by itself has a DOI and gloss reading of at least 80 and 90.

“Weatherability” is defined as improved exterior weathering durability for satisfactory surface appearance.

SAE J1960 titled “Accelerated Exposure of Automotive Exterior Materials Using Controlled Irradiance Water Cooled Xenon-Arc Apparatus”, is an accelerated weathering protocol using Xenon-arc light with varying exposures of light, dark and water spray. Specimens weathered in an accelerated weatherometer such as an Atlas' Ci5000 Weather-Ometers are evaluated based on retained gloss and L,a,b color. Retained gloss is considered the change in gloss divided by initial gloss level. Change in color is in delta E.

The multi-layer sheet or laminate comprises a first thick clear surface polymeric layer of a polyolefin, more particularly, an ionomer resin of a copolymer of ethylene and a co-monomer with the co-monomer content being between 8-25% by weight, based on the weight of the copolymer, of a C₃-C₈ α,β ethylenically unsaturated mono-carboxylic acid with at least 35% of the acid groups neutralized with metal ions. This layer is clear but may contain pigments that are transparent or have the same refractive index as the ionomer resin making the layer appear clear and contain at least one hindered amine light stabilizer in the amount of 0.2 to 3.0 parts per hundred by weight, based on the weight of ionomer and can contain one or more UV (ultraviolet light) absorbers and other UV stabilizers and other additives and mixtures thereof.

This clear layer is at least 100 μ and up to and including 450 μ in thickness. Preferably, the clear layer is 125-300 μ thick in the final article formed from the sheet material. The initial surface layer thickness is dependent on the amount the clear layer thins during the forming and cladding processes. The resulting part formed needs to have a clear layer that is about 125 μ in thickness to provide adequate weathering protection for several years of exterior exposure, especially for darker colored articles. Typical molded auto, truck and recreational vehicle parts, panels and the like of the multi-layer sheet or laminate material of this invention have this first clear layer that not only provides improved weatherability but is scratch and mar resistant and resistant to elevated temperatures.

The second polymeric layer can be an under layer or a pigmented layer that carries pigments, dyes, flakes, such as aluminum flake and other additives and any mixtures of the above. An ionomer resin can be used for this layer. Preferably, an ionomer resin used in the clear and pigmented layers and preferably is the same resin or a very compatible resin for the second layer and has good inter-layer adhesion. If two different resins are used in the clear layer and the pigmented layer, the resins must be compatible in processing and have adequate inter-layer adhesion. Other resins that can be used are ethylene acid copolymers, such as ethylene/acrylic acid and ethylene/methacrylic acid copolymers; ethylene copolymers, ethylene/acid terpolymers, such as ethylene/vinyl acetate/acrylic acid polymers, ethylene/(meth)acrylic acid/alkyl(meth)acrylate polymers having 2-12 carbon atoms in the alkyl group, like, ethylene/acrylic acid/butyl acrylate polymers. A metallocene catalyzed very low density polyethylene (m-VLDPE) can be used. One particularly suitable m-VLDPE is EXACT® 8201, an octane ethylene co-polymer having a density of 0.88 g/cm³ made by Exxon Mobil Corporation. Also, ethylene/vinyl acetate copolymers can be used. The polymer used in this layer must process satisfactorily with the clear layer and the adhesive layer when co-extrusion process is used to form the sheet. Alternatively, a process that does not utilize co-extrusion can be employed to provide the clear thick polyolefin surface material onto a colored polymeric substrate.

Optionally, a third layer that can be in contact with the second colored layer and is an adhesive layer that bonds the colored layer to a backing layer. This layer and any subsequent layers can provide adhesive characteristics that bond the colored layer to a backing or substrate layer(s). Typically useful polymers that provide adhesive characteristics are one of the aforementioned ethylene/acid copolymers, ethylene/acid terpolymers, ethylene copolymers, ethylene/(meth)acrylic acid/alkyl (meth)acrylate polymers, and metallocene catalyzed very low density polyethylene (m-VLDPE). Particularly useful are the metallocene catalyzed very low density polyethylene (m-VLDPE) polymers since they provide a high level of adhesion. EXACT® 8201, described above, is one preferred polymer.

An optional fourth layer can be any of a variety of polymers to further provide for adhesive characteristics for adhering to a substrate. Typical are polypropylene, copolymers of polypropylene, random copolymers of polypropylene, blends of polypropylene and other polyolefins, polyesters, polyamides, polyester copolymers, polyamide copolymers, Bexloy® W—a blend of ionomer resin and polyethylene. Adhesive layers usually need to be tailored for the specific backing layer, such as an m-VLDPE which provides high adhesion between an ionomer layer (second layer) and a polypropylene copolymer backing layer (fourth layer).

The sheet material can have, as mentioned above, an 100450 μ thick first polymeric clear layer and an 80-600 μ thick second polymeric pigmented layer and optionally, a 40-500 μ thick third adhesive layer and further optionally, a 200-800 μ thick fourth layer with a total thickness of about 400-1600 μ. In forming a part, the novel sheet material is thermoformed and then cladded with a relatively thick layer of an engineering polymer to provide the resulting part with the desired stiffness and handling ability. Typically, the cladding layer may be 800-4000 μ thick depending on the design of the part or panel which may be for autos, trucks, recreational vehicles, garden equipment and the like. Alternately, the multilayer sheet or laminate may be formed by blow molding. Alternatively, the sheet has an 100-450 μ thick first polymeric clear layer, with or without subsequent polymeric layer(s) coated onto a non-woven or porous web. An underlayer carries pigments, dyes, flakes, such as aluminum flake, other additives and mixtures thereof.

The following is a theoretical discussion on exterior weathering effects and is provided to help clarify the invention. Applicants do not wish to be bound by this theory.

Polymer micro-cracking caused by outdoor weathering for structures having a clear layer over a color or pigmented under layer surprisingly can be reduced with the use of a thicker clear layer. Degradation appears to predominate the clear layer to color layer interface. The clear layer exhibits significantly reduced cracking and gloss loss on the surface during extended weathering. Micro-cracking which is an indication of degradation, in the clear layer, which preferably is an ionomer structure, is initiated near the interface of the clear and color layers. The color layer containing pigments absorbs more radiation than the clear layer, increasing the temperature of the colored layer near the interface. Low heat conduction of the polymeric materials used result in the temperature increasing in the volume of polymeric material around the interface of the two layers. Oxygen, a reactive element, often is involved in degradation, migrates from the surface of the sheet toward the interface of the clear and color layers and beyond. An oxygen concentration gradient likely exists between the polymer close to the surface (higher concentration) and the polymer near the interface (lower concentration). Higher temperature near the clear color interface coupled with an increased level of oxygen concentration increases the kinetics of degradation in the region of the interface, which reduces weathering durability. A thicker clear layer reduces the oxygen concentration near the interface thereby reducing degradation rates and increasing weathering durability.

During exterior weathering, significant light radiation is absorbed in the color (pigmented) layer, especially closer to the clear layer interface. The energy absorbed increases the local temperature, which runs significantly above the sample surface temperature due to low heat conduction of the polymeric material of the sheet material which retards the removal of heat. The higher temperature in the clear-color layer interface volume increases degradation kinetics leading to cracking near this interface as an early manifestation of degradation. Increasing the clear layer thickness improves weathering durability, very likely through reducing diffusion of oxygen and or moisture to the warm zone near the pigment interface. Since darker colors typically absorb more radiation, they run with a hotter temperature and degrade faster.

Based on the above hypothesis, the following can be used to improve weathering performance:

a. Increasing the thickness of the clear surface layer in conjunction with suitable UV additives at increased levels;

b. Providing suitable UV additives at increased levels, especially near the layers of the clear/color interface;

c. Splitting the clear layer into 2 layers. Assuming a constant overall thickness of clear layer, the layer adjacent to the pigmented layer can be loaded with higher UV additive levels to improve performance and reduce cost relative to the entire clear layer thickness containing the high level of UV additives. Hindered amine light stabilizers are the most beneficial.

d. Improving the barrier properties of the clear surface layer to reduce the diffusion of oxygen or moisture to the warm clear/pigmented layers interface would improve weathering durability. Nanocomposites which are small enough to not scatter light yet which provide barrier properties can be used;

e. Partitioning the pigmented layer into 2 or more layers. By reducing the concentration of absorbing materials in the layer adjacent to the clear layer/color layer interface, the level of energy absorption and concurrent temperature level can be reduced or spread over a greater volume. Utilizing a dilute level of absorbing materials in the layer adjacent to the clear layer, the hot volume at the interface can be tempered through diffusing energy dissipation over greater volume, reducing degradation rates and moving the degradation volume further away from the oxygen-moisture environment at the surface; or

f. Combinations of any the above.

Preferably, an ionomer resin is used for the surface of the multi-layer sheet material of this invention. The ionomer resin is prepared using typical reaction temperatures and pressures and when neutralized with metal ions, in particular zinc, sodium, magnesium, calcium and any mixtures thereof forms a surface layer that has excellent scratch and mar resistance and temperature resistance. Typically useful ionomers have an acid mole content above 0.7%, neutralization of the acid functional groups to a level greater than 40% and a MI (Melt Index) of less than 5 and preferably in the range of 0.2 -4.0.

The ionomers of the present invention are derived from direct copolymers of ethylene and a C₃-C₈ α,β ethylenically unsaturated mono-carboxylic acid (ethylene acid copolymer) that is at least 35% neutralized with metal ions. By “direct copolymer”, it is meant that the copolymer is made by polymerization of monomers together at the same time, as distinct from a “graft copolymer” where a monomer is attached or polymerized onto an existing polymer chain. Methods of preparing such ionomers are well known and are described in U.S. Pat. No. 3,264,272, which is herein incorporated by reference. Preparation of the direct ethylene-acid copolymers on which the ionomers are based is described in U.S. Pat. No. 4,351,931, which is also incorporated by reference herein. Ethylene-acid copolymers with high levels of acid are difficult to prepare in a continuous polymerization because of monomer-polymer phase separation. This difficulty can be avoided however by use of “co-solvent technology” as described in U.S. Pat. No. 5,028,674, which is also incorporated herein by reference or by employing higher pressures than those at which copolymers with lower acid can be prepared.

The ethylene-acid copolymers used to make the ionomeric copolymer of this invention can be copolymers of ethylene and C₃-C₈ α,β ethylenically unsaturated mono-carboxylic acid, particularly acrylic or methacrylic acid. Preferred ethylene-acid copolymers are ethylene/acrylic acid and ethylene/methacrylic acid.

The ethylene-acid copolymers used to make the ionomer copolymers of this invention can have the acid moiety present in a high amount. The amount that will be considered as “high” will depend on which acid moiety is employed, particularly the molecular weight of the acid moiety. In the case of ethylene/(meth)acrylic acid, the preferred acid level is 10 to 25, (preferably 12 to 20, more preferably 13 to 19) wt. % based on the weight of the copolymer. Particularly in view of the disclosures herein, one skilled in the art will be able to determine the “high” acid levels for other acid moieties that are needed to get the desired gloss levels and abrasion resistance. Useful acid copolymer can include ethylene/12.5% acrylic acid and ethylene/15% methacrylic acid. Generally, if the acid level of the copolymer is increased transition temperatures are lowered while the available acid moieties for neutralizing increase. Higher levels of neutralization (acid level times neutralization extent) improve hardness and mar resistance. A proper balance of acid level is therefore necessary to balance surface mar and temperature resistance.

The neutralizing moiety is preferably metal cations, particularly monovalent and/or bivalent metal cations. It is preferable to neutralize with metal cations. Preferred metal cations include sodium, zinc, lithium, magnesium and calcium or a combination of such cations. A combination of zinc and sodium is most preferred.

The preferred level of neutralization can depend on the ethylene-acid copolymers employed and the properties desired. Neutralization should be sufficient to raise the scratch/mar resistance and hardness to satisfactory levels. The percent neutralization of the acid groups preferably is about 35% or greater. The level of acid and the degree of neutralization can be adjusted to achieve the particular properties desired.

The ionomer also can contain hindered amine light stabilizers and components such as, other UV light stabilizers, UV absorbers, antioxidants and thermal stabilizers, clear pigments, fillers, anti-slip agents, plasticizers, nucleating agents, and the like. Preferably, these components are present in amounts of about 0.2 to about 3.0 (preferably, about 0.5 to about 2.0) parts per hundred parts by weight, based on the weight of the ionomer, but may be present in lower or higher levels.

The second polymeric layer can be a colored or pigmented layer containing pigments, dyes, flakes, such as aluminum flake, other additives and mixtures thereof. An ionomer resin can be used for this pigmented layer. The ionomer resin used in the pigmented layer can be any of those described above for the first clear layer and preferably, the same resin or a very processing compatible ionomer resin is used to insure that there is good inter-layer adhesion and appearance between the first and second layers when a co-extrusion process is used to form the novel sheet material.

If two different resins are used in the clear layer and the pigmented layer, the resins are preferably compatible when using co-extrusion processing and have adequate inter-layer adhesion. Other resins that can be used for this pigmented layer are ethylene acid copolymers, such as ethylene/acrylic acid and ethylene methacrylic acid copolymers; ethylene/acid terpolymers, such as ethylene/vinyl acetate/acrylic acid polymers, ethylene/(meth)acrylic acid/alkyl(meth)acrylate polymers having 2-12 carbon atoms in the alkyl group, like ethylene/acrylic acid/butyl acrylate polymers. A metallocene-catalyzed very low density polyethylene (m-VLDPE) can be used. Also, ethylene/vinyl acetate polymers can be used. The polymer used in this layer is preferably processible not only with the clear layer but with the subsequently applied adhesive layer.

If co-extrusion processing is not employed, other processes can be used. An example to fabricate a thick clear surface polyolefin layer over a colored layer includes extrusion coating of a clear layer onto a colored substrate, such as a non-woven or porous web substrate that provides adequate adhesion.

An optional third polymeric layer can be used to provide adhesion to the second pigmented polymeric layer and to a subsequent backing layer and can be tailored to the specific system desired. Typically useful polymers for this adhesive layer are one of the aforementioned ethylene/acid copolymers, ethylene/acid terpolymers, ethylene copolymers, ethylene/(meth)acrylic acid/alkyl (meth)acrylate polymers, and metallocene catalyzed very low density polyethylene (m-VLDPE). Particularly useful are the metallocene catalyzed very low density polyethylene (m-VLDPE) polymers since they provide a high level of adhesion between an ionomer layer and a polypropylene layer especially a random copolymer of polypropylene.

These metallocene catalyzed very low density polyethylenes (m-VLDPE) are made using conditions well known in the art for continuous polymerization. Typically polymerization temperatures of 0-250° C. and pressures from atmospheric to 1000 atmospheres (110 MPa) are used. Suspension, solution, slurry, gas phase or other polymerization methods can be used. A support for the catalyst can be used but preferably the catalysts are used in a homogeneous (soluble) manner. Suitable process conditions and catalysts that can be used to form the metallocene catalyzed polyethylenes used in this invention are disclosed in U.S. Pat. No. 5,324,800, U.S. Pat. No. 5,278,272, U.S. Pat. No. 5,272,236, U.S. Pat. No. 5,405,922, U.S. Pat. No. 5,198,401 which patents are hereby incorporated by reference. Preferred m-VLDPE can have a density of 0.86 to 0.91 g/cm³ and a MI of 0.5-4.0 g/10 min. measured in accordance with ASTM D1238 such as for example, m-VLDPE is EXACT 8021.

An optional fourth polymeric material can be used and can be any of a variety of polymers that provide the necessary adhesion to cladding materials which provide other desirable attributes backing stiffness. Typically useful are polypropylene, copolymers of polypropylene, random copolymers of polypropylene, blends of polypropylene and other polyolefins, BEXLOY® W-ethylene/ionomer resin, polyethylene terephthalate copolymers, PETG, blends of polyethylene terephthalate and polybutylene terephthalate, polyamides, and polyamide copolymers and the like can be used.

In the formation of a part or panel from the novel multi-layer sheet material or laminate, a cladding material can be any of the aforementioned materials used in the fourth layer provide the materials are processible and provide a high level of adhesion. Typically useful cladding materials are any of the above such as polypropylene, copolymers and blends thereof, polyethylene terephthalate, polyamides, filled counterparts of these materials and other high modulus resins conventionally used in the manufacture of parts and panels for autos, trucks and recreational vehicles.

Alternatively, a single step multi-layer blow molding process can be used to produce end use articles.

Additives normally compounded into plastics or added to coating compositions may be included in the first and second polymeric layer as required for the end use of the resulting product that is formed, i.e., automotive or truck part or panel. As stated above, the clear layer contains hindered amine light stabilizers which can also be included in the second pigmented layer if desired. Typical of the other materials that can be added are, for example, UV absorbers, additional or other hindered amine light stabilizers, antioxidants and thermal stabilizers, processing aids, pigments and the like. These components are preferably present in amounts of about 0.5 to about 3.0 (preferably about 1.0 to about 2.0) parts per hundred parts by weight of the polymeric material but may be present in lower or higher amounts.

Typical UV hindered amine light stabilizers are bis(1,2,2,6,6 pentamethyl-4-piperidinyl sebacate) and di[4(2,2,6,6,tetramethyl piperidinyl)]sebacate, poly[[6-[1,1,3,3-tetramethylbutyl]amino-s-triazine-2,4-diyl][(2,2,6,6-tetramethyl-4-piperidyl)imino]hexamethylene[(2,2,6,6-tetramethyl-4-piperidyl)iminol]], Chimassorb® 2020 1,6-hexanediamine, N,N′-bis(2,2,6,6-tetramethyl 1 -4-piperidyl)-, polymer with 2,4,6-trichloro-1,3,5-triazine, reaction products with N-butyl-1-butanamine and N-butyl-2,2,6,6-tetramethyl-4-piperidinamine, Tinuvin® NOR 371, a triazine derivative and any mixtures thereof.

Typically useful UV absorbers include: benzophenones such as hydroxy dodecyloxy benzophenone, 2,4-dihydroxybenzophenone, hydroxybenzophenones containing sulfonic groups and the like; triazoles such as 2-phenyl-4-(2′,2′-dihydroxylbenzoyl)-triazoles; substituted benzothiazoles such as hydroxyphenylthiazoles and the like; triazines such as 3,5-dialkyl-4-hydroxyphenyl derivatives of triazine, sulfur containing derivatives of dialkyl-4-hydroxy phenyl triazines, hydroxy phenyl-1,3,5-triazine and the like; benzoates such as dibenzoate of diphenylol propane, tertiary butyl benzoate of diphenylol propane and the like; and others such as lower alkyl thiomethylene containing phenols, substituted benzenes such as 1,3-bis-(2′-hydroxybenzoyl)benzene, metal derivatives of 3,5-di-t-butyl-4-hydroxy phenyl proprionic acid, asymmetrical oxalic acid, diarylarides, alkylhydroxy-phenyl-thioalkanoic acid ester, and hindered amines of bipiperidyl derivatives.

Preferred UV absorbers and hindered amine light stabilizers, all available from Ciba Geigy, are TINUVIN®.234 (2-(2H-benzotriazol-2-yl)-4,6-bis(1-methyl-1-phenylethyl)phenol), TINUVIN® 327 (2-(3′,5′-di-tert-butyl-2′-hydroxyphenyl)-5 chlorobenzotriazole), TINUVIN® 328 (2-(2′hydroxy-3′,5′-di-tert-amylphenyl)benzotriazole), TINUVIN® 329 (2-(2′-hydroxy-5′-tert-octylphenyl)benzotriazole), TINUVIN® 765 (bis(1,2,2,6,6-pentamethyl-4-piperidinyl)sebacate), TINUVIN® 770 (bis(2,2,6,6-tetramethyl-4-piperidinyl) decanedioate), CHIMASSORB® 2020 1,6-hexanediamine, N,N′-bis(2,2,6,6-tetramethyl 1-4-piperidyl)-, polymer with 2,4,6-trichloro-1,3,5-trianzine and CHIMASSORB® 944 (N,N-bis(2,2,6,6-tetramethyl-4-piperidinyl)-1,6-hexanediamine polymer with 2,4,6-trichloro-1,3,5-triazine and 2,4,4-trimethyl-1,2-pentanamine.

Preferred thermal anti-oxygen stabilizers, all available from Ciba Geigy, are IRGANOX® 259 (hexamethylene bis(3,5-di-tert-butyl-4-hydroxyhydrocinnamate), IRGANOX® 1010 (3,5-bis(1,1-dimethylethyl)-4-hyroxybenzenepropanoic acid, 2,2-bis[[3-[3,5-bis(1,1-dimethylethyl)-4-hydroxyphenyl]-1-oxopropoxy]methyl]1, 3-propanediyl ester), IRGANOX® 1076 (octadecyl 3,5-di-tert-butyl4-hydroxyhydrocinnamate), Iragnox® 1098 (N,N-hexamethylene bis(3,5-di-tert-butyl-4-hydroxyhydrocinnamamide), IRGANOX® B215 (33/67 blend of IRGANOX® 1010 with tris(2,4-di-tert-butylphenyl)phosphite), IRGANOX® B225 (50/50 blend of IRGANOX®1010 with tris(2,4-di-tert-butylphenyl)phosphite), and IRGANOX® B1171 (50/50 blend of IRGANOX® 1098 with tris(2,4-di-tert-butylphenyl)phosphite).

Pigments include both clear pigments, such as inorganic siliceous pigments (silica pigments for example) and conventional pigments. Conventional pigments include metallic oxides such as titanium dioxide, and iron oxide; metal hydroxides; metal flakes such as aluminum flake; chromates such as lead chromate; sulfides; sulfates; carbonates; carbon black; silica; talc; china clay; phthalocyanine blues and greens, organo reds; organo maroons and other organic pigments and dyes. Particularly preferred are pigments that are stable at high temperatures. Pigments are generally formulated into a millbase by mixing the pigments with a dispersing resin that may be the same as or compatible with the material into which the pigment is to be incorporated. Pigment dispersions are formed by conventional means such as sand grinding, ball milling, attritor grinding or two-roll milling. Other additives, while not generally needed or used, such as fiber glass and mineral fillers, anti-slip agents, plasticizers, nucleating agents, and the like, can be incorporated.

The sheet material can be made using melt co-extrusion processes known to those skilled in the art. For example, the sheet material can be formed by charging each of the polymer components for the various layers of the sheet material into separate extruders and melting the component and pumping the melted component through a pipe into a feed block that layers the different flows together just prior to entering an extrusion die manifold. A molten curtain of multiple layers exits the extrusion die.

In one process, the molten curtain of multiple layers can be deposited across the width of a moving roll which transfers the cooling multi-layer sheet material into a counter rotating moving roll through a gap or nip and then typically to a third cooling roller and subsequently through a take-off system to another nip between two rollers which pulls the sheet to a take-off system. The above arrangement provides a consistent finish to the sheet that has high gloss and forms a sheet having a uniform thickness.

In another process, the molten curtain of multiple layers, with a thick clear surface layer and colored underlayer can form a hollow column like shape that can be inflated into a mold to form a part.

Parts formed with the sheet material or laminate of this invention are surprisingly weatherable and particularly stabile when exposed to ultraviolet light for extended periods of time. These parts exhibit the low color shift, measured using, for example, the CIE 1976 (CIE LAB) color scale, needed for molded parts used in exterior applications. They exhibit AE color shift values of less than about 3 (a level considered as suitable for exterior automotive applications) when exposed to 2500 kilojoules/square meter in a Xenon-arc weatherometer (SAE J1960). Improved automobile fascia having DOI of at least 80 and superior mar resistance can be made.

The following examples illustrate, but not limit the scope of, the invention. All parts and percentages are on a weight basis.

### EXAMPLE 1

Similar multi-layered constructions of different colored sheets were fabricated with a thermocouple imbedded between the multi-layer pigmented sheet and an injection cladded backing layer. The precursor sheet was a two-layer construction with a clear ionomer and pigmented ionomer layers. A thermocouple was attached to the backside pigmented layer and a thicker ionomer backing was injection clad to the sheet producing a three layer construction with a clear surface layer, a pigmented second layer and a thicker clear backing layer. Approximate thickness for each layer was 5 mils (127 μ) clear layer, 18 mils (457.2 μ) color layer and 100 mils (2540 μ) clear backing layer. The pigment loading of the second layer was such that it provided hiding power sufficient to maintain the visual color appearance independent of a background color behind the sheet.

Surlyn® 1706—an ionomer resin zinc neutralized ethylene/methacrylic acid copolymer, MI (melt index) 0.65.

SEP 1068—12.5% acrylic acid/ethylene copolymer neutralized with Na and having a Vicat temperature of 75-80° C.

The Hanna pigments were from Hanna's Norwalk, Ohio, U.S.A. plant. Hanna is part of PolyOne Corporation.

TABLE 1
Multilayer Sheet Materials

| Sample color | Layer 1 | Layer 2 | Layer 2 Pigment | Layer 3 |
|---|---|---|---|---|
| Clear | Surlyn@1706 | Surlyn@1706 | None | SEP1068 |
| Bright Silver | Surlyn@1706 | Surlyn@1706 | Silver 5% Hanna | SEP1068 |
| Metallic | | | XMZ6121NMB | |
| White | Surlyn@1706 | Surlyn@1706 | White 10% Hanna | SEP1068 |
| | | | MZ093727NMB | |
| Black | Surlyn@1706 | Surlyn@1706 | Black 5% Hanna | SEP1068 |
| | | | XMZ47564NMB | |
| Dark Green | Surlyn@1706 | Surlyn@1706 | Green 6% | SEP1068 |
| Metallic | | | HannaXMZ61245NMB | |
| Red | Surlyn@1706 | Surlyn@1706 | Red 6% Hanna | SEP1068 |
| | | | XMZ104540NMB | |

The above-prepared samples were loaded into a weatherometer which was being controlled for SAE J1960 accelerated weathering conditions. A black painted metal panel with a temperature sensor in the weatherometer is used to control radiant energy of the Xenon-arc light source. The metal panel temperature goal set point in the light segment of the cycled test is 70° C. The multi-layer plastic samples with a thermocouple imbedded in them between the second layer and the injection cladded backing layer or third layer were in turn attached to a temperature recorder strip chart and thermocouple temperatures were recorded for the different sample colors. The plastic sample colors, solar transmittance reflectance, absorptance and sample thermocouple temperatures are shown below when the machine was being controlled for a metal panel temperature of 70° C.

TABLE 2

| | | Solar | Solar | | |
|---|---|---|---|---|---|
| | | Trans. | Trans. | | |
| Sample | Chamber | Reflec- | Reflec- | | Sample |
| Color | Air Temp. | tance | tance | Absorptance | T/C Temp |
| Clear | 47 (° C.) | 69.7 | 9.6 | 20.6 | 60 (° C.) |
| Bright | 47 (° C.) | 0.0 | 47.7 | 52.3 | 69 (° C.) |
| Silver | | | | | |
| Metallic | | | | | |
| White | 47 (° C.) | 0.2 | 47.2 | 52.6 | 69 (° C.) |
| Black | 47 (° C.) | 0.0 | 5.0 | 95.5 | 80 (° C.) |
| Dark Green | 47 (° C.) | 0.0 | 9.0 | 91.0 | 78 (° C.) |
| Metallic | | | | | |
| Red | 47 (° C.) | 10.9 | 37.9 | 51.2 | 63 (° C.) |

### EXAMPLE 2

Similar multi-layered constructions of different colored sheets were fabricated with a similar UV additive package for each layer. The precursor sheet was a four layer construction with a clear ionomer surface layer, a pigmented ionomer second layer, an adhesive third layer and a polypropylene (PP) based backing layer. The sheet was injection cladded with a PP material producing a five layer construction with a clear surface layer, a pigmented second layer, and adhesive third layer, a PP fourth layer and a cladded PP thick layer. Approximate thickness for each layer was 5 mils clear layer, 12 mils colored layer, 4 mils adhesive layer, 10 mils sheet back layer and 90 mils PP cladding layer. The pigment loading of the second layer was such that it provided hiding power sufficient to maintain the visual color appearance independent of a background color behind the sheet. The samples were subjected to J1960 accelerated weathering and real time Florida weathering. The retained gloss for all samples was acceptable for automotive use.

1. A multi-layer sheet comprising, or produced from,
(a) a first layer, comprising thermoplastic polymeric polyolefin, which is characterized as a clear layer having a thickness of at least 100 μand optionally comprising UV a light absorber, a hindered amine light stabilizer, or both;
(b) a second layer or under layer, which is a polymer layer, comprising pigment, dye, flake, and any mixtures thereof;
(c) optionally a third layer, comprising a thermoformable polymeric adhesive, that is in direct contact with the second polymeric layer; and
(d) optionally a backing layer (fourth layer).

2. The sheet of claim 1 wherein said first layer comprising one or more ionomer resins of a copolymer of ethylene and 8-25% by weight, based on the weight of the copolymer, of a C₃-C₈ α,β ethylenically unsaturated monocarboxylic acid at least 35% of the acid moieties neutralized with metal ions and comprising 0.2 to 3.0 parts per hundred, based on the weight of the ionomer resin, of at least one hindered amine light stabilizer.

3. The sheet of claim 1 wherein said first layer consisting essentially of one or more ionomer resin of a copolymer of ethylene and 8-25% by weight, based on the weight of the copolymer, of a C₃-C₈ α,β ethylenically unsaturated monocarboxylic acid at least 35% of the acid moieties neutralized with metal ions and comprising 0.2 to 3.0 parts per hundred, based on the weight of the ionomer resin, of at least one hindered amine light stabilizer.

4. The sheet of claim 1 wherein said second layer comprising one or more ionomer resin, ethylene acid copolymer, ethylene acid terpolymer, ethylene copolymer, or a metallocene-catalyzed very low density polyethylene

5. The sheet of claim 2 wherein said second layer comprising one or more ionomer resin, ethylene acid copolymer, ethylene acid terpolymer, ethylene copolymer, or a metallocene-catalyzed very low density polyethylene

6. The sheet of claim 3 wherein said second layer consisting essentially of one or more ionomer resin, ethylene acid copolymer, ethylene acid terpolymer, ethylene copolymer, or a metallocene-catalyzed very low density polyethylene.

7. The sheet of claim 1 wherein the first layer comprises an ionomer resin of ethylene and 10-25% by weight, based on the weight of the copolymer, of meth(acrylic) acid and neutralized with metallic ion selected from the group consisting of zinc, sodium, magnesium, calcium and any mixtures thereof and having a Melt Index of 0.2-4.0.

8. The sheet of claim 2 wherein the first layer comprising an ionomer resin of ethylene and 10-25% by weight, based on the weight of the copolymer, of meth(acrylic) acid and neutralized with metallic ion selected from the group consisting of zinc, sodium, magnesium, calcium and any mixtures thereof and having a Melt Index of 0.2-4.0.

9. The sheet of claim 4 wherein the first layer comprising an ionomer resin of ethylene and 10-25% by weight, based on the weight of the copolymer, of meth(acrylic) acid and neutralized with metallic ion selected from the group consisting of zinc, sodium, magnesium, calcium and any mixtures thereof and having a Melt Index of 0.2-4.0.

10. The sheet of claim 3 wherein the first layer consisting essentially of an ionomer resin of ethylene and 10-25% by weight, based on the weight of the copolymer, of meth(acrylic) acid and neutralized with metallic ion selected from the group consisting of zinc, sodium, magnesium, calcium and any mixtures thereof and having a Melt Index of 0.2-4.0.

11. The sheet of claim 6 wherein the first layer consisting essentially of an ionomer resin of ethylene and 10-25% by weight, based on the weight of the copolymer, of meth(acrylic) acid and neutralized with metallic ion selected from the group consisting of zinc, sodium, magnesium, calcium and any mixtures thereof and having a Melt Index of 0.2-4.0.

12. The sheet of claim 1 wherein the second layer comprises an ionomer resin, ethylene acid terpolymer, or metallocene-catalyzed very low density polyethylene, each processible with the polyolefin of the first layer.

13. The sheet of claim 2 wherein the second layer comprises an ionomer resin, ethylene acid terpolymer, or metallocene-catalyzed very low density polyethylene, each processible with the polyolefin of the first layer.

14. The sheet of claim 3 wherein the second layer comprises an ionomer resin, ethylene acid terpolymer, or metallocene-catalyzed very low density polyethylene, each processible with the polyolefin of the first layer.

15. The sheet of claim 4 wherein the second layer comprises an ionomer resin, ethylene acid terpolymer, or metallocene-catalyzed very low density polyethylene, each processible with the polyolefin of the first layer.

16. The sheet of claim 6 wherein the second layer comprises an ionomer resin, ethylene acid terpolymer, or metallocene-catalyzed very low density polyethylene, each processible with the polyolefin of the first layer.

17. The sheet of claim 7 wherein the second layer comprises an ionomer resin, ethylene acid terpolymer, or metallocene-catalyzed very low density polyethylene, each processible with the polyolefin of the first layer.

18. The sheet of claim 8 wherein the second layer comprises an ionomer resin, ethylene acid terpolymer, or metallocene-catalyzed very low density polyethylene, each processible with the polyolefin of the first layer.

19. The sheet of claim 9 wherein the second layer comprises an ionomer resin, ethylene acid terpolymer, or metallocene-catalyzed very low density polyethylene, each processible with the polyolefin of the first layer.

20. The sheet of claim 10 wherein the second layer comprises an ionomer resin, ethylene acid terpolymer, or metallocene-catalyzed very low density polyethylene, each processible with the polyolefin of the first layer.

21. The sheet of claim 11 wherein the second layer comprises an ionomer resin, ethylene acid terpolymer, or metallocene-catalyzed very low density polyethylene, each processible with the polyolefin of the first layer.

22. The sheet of claim 1 wherein the first clear layer is 100-450 μ thick.

23. The sheet of claim 2 wherein the first clear layer is 100-450 μ thick.

24. The sheet of claim 7 wherein the first clear layer is 100-450 μ thick.

25. The sheet of claim 10 wherein the first clear layer is 100-450 μ thick.

26. The sheet of claim 11 wherein the first clear layer is 100-450 μ thick.

27. The sheet of claim 1 further comprising the third layer.

28. The sheet of claim 2 further comprising the third layer.

29. The sheet of claim 7 further comprising the third layer.

30. The sheet of claim 20 further comprising the third layer.

31. The sheet of claim 21 further comprising the third layer.

32. The sheet of claim 24 further comprising the third layer.

33. A product comprising, or produced from, a multi-layer polymer sheet wherein the product is an auto part, a truck part, an auto or truck body panel, or a part or panel of a recreational vehicle having a Class A surface and the sheet is as recited in claim 1.

34. The product of claim 33 wherein the sheet is as recited in claim 2.

35. The product of claim 33 wherein the sheet is as recited in claim 4.

36. The product of claim 33 wherein the sheet is as recited in claim 6.

37. The product of claim 33 wherein the sheet is as recited in claim 7.

38. The product of claim 33 wherein the sheet is as recited in claim 10.

39. The product of claim 33 wherein the sheet is as recited in claim 21.

40. The product of claim 33 wherein the sheet is as recited in claim 27.
